(19) United States
(12) Patent Application Publication
(10) Pub. No.: US 2009/0246419 A1
(43) Pub. Date: Oct. 1, 2009

(54) Ornament and Method

(75) Inventor: Mark Robert LORBEK, Emerald (AU)

Correspondence Address: KIRK HAHN, 14431 HOLT AVE, SANTA ANA, CA, 92705, US

(73) Assignee: AUTOFLYER PTY. LTD., East Malvern (AU)

(21) Appl. No.: 12/269,715

(22) Filed: Nov. 12, 2008

(30) Foreign Application Priority Data
Nov. 12, 2007 (AU) 2007906184

(51) Int. Cl. B60R 13/00; C08J 5/00; B32B 37/12; G06Q 90/00

(52) U.S. Cl. 428/31; 264/331.11; 156/60; 705/1

(57) ABSTRACT

An ornament for mounting on vehicle antennas and similar elongate upright structures, which move in response to a flow of air, and a range of different ornaments of this type.

### FIELDS OF THE INVENTION

The inventions disclosed herein are firstly an improved ornament for mounting slideably on vehicle antennas and similar elongate upright structures and that moves in response to a flow of air, and secondly a method for provision of a range or set of different ornaments of this type and such a range of ornaments.

### BACKGROUND

Many people wish to demonstrate to others their preferences in respect of sporting teams, sportspersons, political parties and candidates, cities, schools, sporting codes, brands of goods and the like. Many businesses wish to accommodate this desire by supplying suitable products.

One particular way of doing this is to provide ornaments that can be secured to vehicle whip-type or telescopic antennas or to other elongate upright structures, the ornaments signifying by an indicium thereon a particular preference.

A difficulty faced by suppliers of such ornaments is accommodating the enormous range of preferences that potential customers may wish to demonstrate, at reasonable cost. The present inventions address this problem with ornaments that can be secured slideably on a vehicle radio antenna or similar upright elongate structure.

It is often the case that people wish to demonstrate their support for, or that a business wishes to advertise, not only an individual entity but a grouping of which that entity is a member. Thus for example, football fans may wish to support a particular player and the team in which he or she plays. Alternatively, such a fan may wish to support one code of football as opposed to another and also a particular team. A political party may wish to promote itself and a particular candidate. A manufacturer of foods or beverages or motor vehicles or other products may wish to advertise its “house” brand and a particular product within its range.

The present invention addresses this requirement also.

### SUMMARY OF THE INVENTION

Everywhere in this specification, the word “comprise” and such derivatives as “comprises”, “comprising”, and “comprised”, where used in relation to a set of items, integers, features or steps is to be taken to mean that those items, integers, features or steps are present, but without precluding the possibility that other items, integers, features or steps are also present.

The terms “airflow” and “wind” are used interchangeably in this specification.

There is provided an ornament for displaying a visual indicium, wherein:

the ornament comprises an assembly mountable to an upright elongate structure and adapted to develop a lifting force in response to a wind flowing past the ornament so as to slide upwards on the structure;

the ornament comprises a first part and a separate second part engaged with each other;

the indicium is comprised in said second part and is visible when the ornament is mounted to said structure.

Very conveniently for a manufacturer and/or supplier, said indicium may be comprised only in the second part, or prominently visibly comprised only in the second part, so that said assembly can be assembled from firstly a first part and secondly a second part that is selected from a group of second parts each adapted to be assembled to the first part and each comprising a different indicium.

In a particular embodiment, there is provided an ornament for displaying a visual indicium said ornament adapted for mounting slideably on an elongate upright structure on a vehicle such as a vehicle radio antenna and adapted to be raised thereon by air flowing past the ornament when the vehicle moves and wherein:

the ornament comprises an assembly of a first part and a second part engaged with each other the first and second parts being separate parts;

the first part is adapted to be mounted slideably on an elongate structure and comprises at least one formation adapted when maintained in a particular orientation to an airflow to develop a lifting force so that the ornament rises on the structure;

the second part is so shaped that when the second part is assembled to the first part the second part responds to the airflow by maintaining the first part in said particular orientation;

the second part comprises at least one visual indicium.

Further preferred features and embodiments are disclosed in the appended claims, which are explicitly intended as a part of the disclosure of the invention.

The second part may comprise a first approximately planar plate-like portion that in use aligns with streamlines of the airflow and wherein said first portion displays a said indicium and a second portion that engages with the first part.

Said indicium may be located on a surface of said first portion.

Said indicium may be applied to the surface of the first portion by one of printing, screen printing, application of a decal, or application of an adhesive sticker or by any other suitable means.

The said first portion of the second part may be so shaped that at least a part of an edge thereof is shaped substantially conformably with an adjacent part of an outer edge of the indicium.

The said second part may be snap-fittingly engageable with said first part.

The first and second parts may be configured to be separable by being pulled apart after being snap-fittingly engaged so as to replace a second part with another second part, but adapted to resist being separated in normal use in an airflow.

Alternatively, the first and second parts may be configured to be inseparable after being placed snap-fittingly into engagement with each other except by damaging at least one of the first and second parts.

In one embodiment the second portion of the second part is receivable in a rearwardly open defined space in the first part and one of the first and second parts has a tab formation that when the second part is moved forwardly into the said space of the first part enters an opening in the other of the first and second parts, the second part deforming during entry of the second part into the space of the first part so as to permit the tab formation to reach enter and thereafter be retained in the said opening.

The first part may have an upper portion defining an upper lifting surface and a lower portion defining a lower lifting surface and at least one joining portion joining the upper and lower portions with said defined space lying between said upper and lower portions and within said joining portion.

The second part may be formed from a sheet material. The sheet material may be a plastics material. The use of sheet plastics material as opposed to injection molding can confer a cost advantage.

The first part may comprise an injection molding in a plastics material.

Apart from the presence of an indicium on the second part, both the first and second parts may in combination amount to a further and separate indicium. For example, it is common for football teams to adopt one or several colours as well as to have a logo or shield-like or badge-like identifying symbol. Thus a surface of the first part may be marked with a first set of colours and a surface of the second part may be marked with a second set of colours, said sets of colours in combination being adopted colours of an entity with the visual indicum on the second part being a visual indicium signifying the same entity.

At least one of said first and second parts may be formed from a material coloured with one of the colours of a said set of colours.

In a further aspect of this first invention there is provided a kit of parts comprising a first part and a second part that are adapted to be assembled together by a user to form the ornament of the invention.

In a further aspect of this first invention there are provided in association separate first and second parts that are adapted to be assembled together to form an ornament as disclosed above.

A second invention provides in a first aspect a method for provision of a range of promotional ornaments each member of the range bearing a different visual indicium,

the ornaments each being ornaments adapted for mounting slideably on a vehicle radio antenna or similar structure and adapted to be raised thereon by air flowing past the ornament when the vehicle moves,

the method comprising the step of supplying to consumers ornaments wherein each individual ornament comprises an assembly including a first and a second part the first part having a configuration common to all members of the range and the second part comprising a visual indicium connoting a particular member of the range.

Each ornament may advantageously be provided to an ultimate user as a kit of the first and second parts, with the step of assembly of these parts being delegated to the ultimate user, thus reducing labour costs and potentially reducing packaging costs. Alternatively however each ornament may be supplied in assembled form.

In a second aspect, the second invention provides a set of different promotional ornaments,

the set comprising a plurality of ornaments each adapted for mounting slideably on an elongate upright structure on a vehicle such as a radio antenna and adapted to be raised thereon by air flowing past the ornament when the vehicle moves

wherein each such ornament that is a member of the set comprises an assembly including a first and a second part the first part having a configuration common to each member of the set and the second part comprising a visual indicium specific to the particular member of the set.

Preferably in performance of the second invention each ornament accords with the first invention.

Although various applications have been mentioned in the Introduction, one example of application of the second invention will be discussed. Sports such as football codes are typically played by a number of teams, organized into a “league” or umbrella organization that arranges fixtures between individual teams and administers the code as a whole. The second invention enables a football fan to buy either a kit comprising a first part and a second part, with the second part having thereon the logo or badge of the fan's preferred club, and then assemble the two parts to make the ornament. Because the first parts are made in numbers larger than would be justified by the number of fans of individual clubs, there may be economies of scale and use of the ornaments by various clubs' fans provides a degree of promotion of the game (i.e. the code) as a whole. The first parts could themselves bear a logo or other indicium of the league as a whole.

Another example of a potential sporting application is provision of a range of ornaments by a single sporting team, with ornaments identifying individual team players corresponding to members of the range of ornaments. A team could offer to its supporters a common first part and a selection of second parts each bearing a picture or other identifier of an individual player, so that a fan could choose the second part relating to a favourite player and assemble it to the common first part.

The term “common to” as used above means that all first parts are identical to each other, or that there is a degree of commonality among the first parts such as to confer an advantage in manufacture or supply of the first parts. For example, if the first part of an ornament sold to supporters of a grouping of football teams is a plastics injection molding, supporters of one team might be provided with first parts of one colour and supporters of another team might be provided with first parts of another colour, but with both first parts being made using the same injection molding die. Different teams may wish to have second parts of radically different design (for example in respect of shape), and the method permits this without greatly enhancing manufacturing costs.

### BRIEF DESCRIPTION OF THE DIAGRAMS

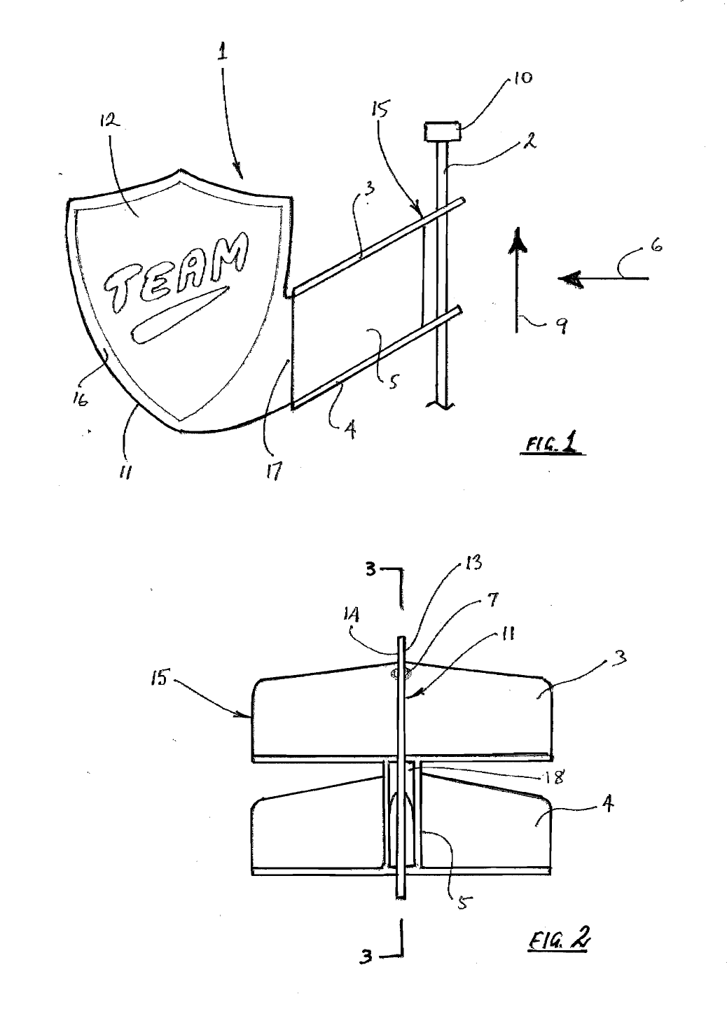

FIG. 1 is a side elevation of an ornament as usable in practice of the inventions, mounted on a vehicle radio antenna;

FIG. 2 is a view from behind of the ornament shown in FIG. 1, now with the antenna omitted;

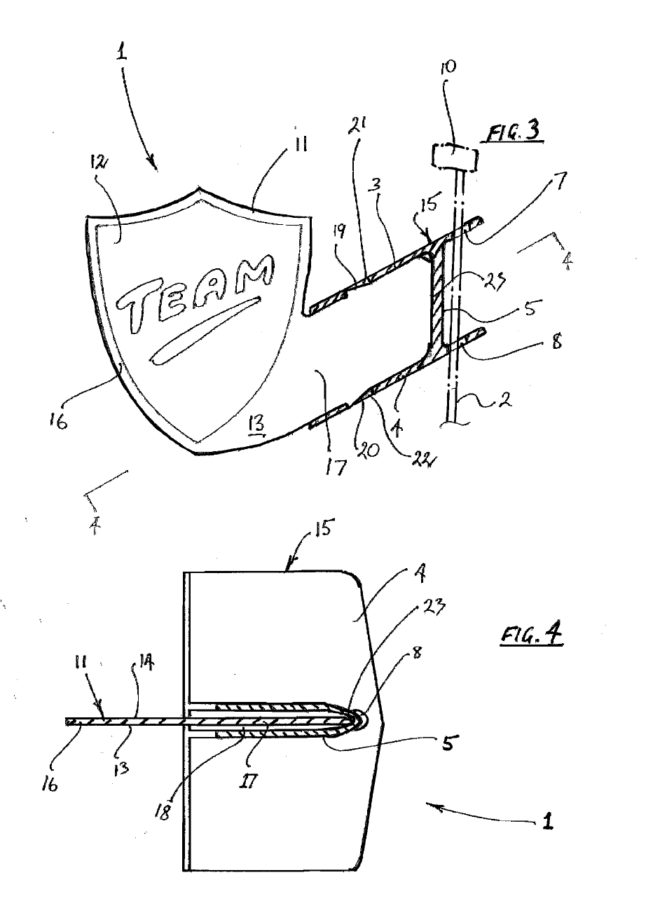

FIG. 3 is a partially cross-sectional view of the ornament as shown in FIG. 2, the section being taken at station “3-3”;

FIG. 4 is a cross-sectional view of the ornament as shown in FIG. 3, the section being taken at station “4-4”.

### DETAILED DESCRIPTION OF PREFERRED EMBODIMENTS

Referring to the diagrams, there is shown an ornament 1 for mounting slideably on a whip-type or telescopic radio antenna 2 (shown only in FIG. 1 and in phantom lines in FIG. 3) of a vehicle. Ornament 2 could alternatively be mounted slideably on an upright elongate structure similar to such a radio antenna, but secured to a vehicle specifically for the purpose of displaying the ornament 2. For convenience, the following description will simply refer to antenna 2, but without any intention to restrict the inventions to use on radio antennas as opposed to similar structures.

Ornament 1 has two lifting elements 3 and 4 similar to the wings of an airplane, extending laterally on both sides of a central body 5. Antenna 2 passes through holes 7 and 8 in elements 3 and 4 respectively and has sufficient clearance for ornament 2 to be able to freely slide up and down antenna 2 and to rotate about antenna 2.

When air flows past the ornament 1 in the direction shown by arrow 6, lifting elements 3 and 4, being at an angle of attack to the airflow, develop an upwardly directed aerodynamic force so that if the force exceeds the weight of ornament 2 ornament 2 can slide upwardly on antenna 2 (as shown by arrow 9. When the airflow is not rapid enough to develop sufficient upward force, ornament 2 slides downward on antenna 2. This airflow-responsive movement of ornament 2 is interesting and eye-catching.

Antenna 2 (of which only a part is shown in FIGS. 1 and 3) may be provided with suitable stop means (not shown) spaced apart along its length to restrict the possible range of movement of ornament 2 on antenna 2. Antenna 2 is shown as having a button 10 at its upper end that can act as an upper stop means to prevent ornament 2 actually leaving antenna 2 when it rises to the top of antenna 2.

The generation of lift by elements 3 and 4 requires that they be so oriented to the airflow 6 as to have a positive angle of attack. To ensure this, ornament 2 is provided with a fin 11 that is generally plate-like, lies in an upright plane, and that in use of ornament 2 lies edgewise to airflow 6. Fin 11 acts in the same way as the tailplane (in American usage, stabilizer) of an airplane. Fin 11 extends rearwardly of the body 5 and of the antenna 2.

Fin 11 is a separate element from the assembly (designated 15) that comprises lifting elements 3 and 4 and body 5 and is secured to that assembly, as described below. Assembly 15 can conveniently be produced as a single injection molding in for example a suitable plastics material.

Fin 11 has emblazoned on either or each of its laterally-facing side surfaces 13 and 14 a logo 12 such as might be used by a sporting team. That part of fin 11 on which logo 12 is emblazoned is also shield-shaped to match the logo 12. Logo 12 may be emblazoned on fin 11 by any suitable method. For example, logo 12 may be printed on decals or adhesive labels that are then secured on surfaces 13 and 14, or may be printed (eg screen printed) directly onto surfaces 13 and 14.

Another possibility is for fin 11 to be made by injection molding in (for example) a plastics and to have the logo 12 embossed on each side of fin 11, with or without application of colour(s) for enhanced visibility.

Instead of injection molding, fin 11 may be cut or stamped from suitable sheet material, such as a plastics material. This, together with the use of decals, adhesive labels or direct printing can provide a manufacturing cost advantage over the manufacture of fin 11 by injection molding. There is a further potential advantage described below.

Fin 11 is snap-fittingly secured to assembly 15 as follows. Fin 11 includes two parts, namely a main portion 16 emblazoned with (and in this example shaped to match the outline of) logo 12 and a tab 17 that extends forwardly from main portion 16. Tab 17 is pushed into a rearwardly-open internal space 18 defined by body 5 and lifting elements 3 and 4 and retained in space 18. When tab 17 is moved forward into space 18, upper and lower barb-shaped tabs 19 and 20 on tab 17 enter upper and lower openings 21 and 22 in lifting elements 3 and 4 respectively and are retained there so as to prevent withdrawal of tab 17 from space 18. Forward edge 23 of tab 17 is located by suitable shaping of the internal surfaces of the forward part of space 18.

Secured to assembly 15 in this way, and if the barbs 19 and 20 and openings 21 and 22 suitably proportioned (which requires no inventive effort), fin 11 is difficult to separate from assembly 15 without the use of tools and/or the causing of damage. This is also a safety feature in that once the two parts 11 and 15 are assembled together they are larger than the comparatively small parts 11 and 15 individually so that they are less hazardous to children.

Alternatively, tabs 19 and 20 may be made rounded (not shown) instead of barb-shaped so that tab 17 can be removed by pulling out of space 18 but will be retained under normal loads applied by airflow in use. This allows different fins 11 (with different indicia 12) to be used with one assembly 15.

It is necessary for tab 17 to bend out of its vertical plane as tab 17 is moved into space 18 and before barbs 19 and 20 enter openings 21 and 22. Thus the material of which fin 11 is made is desirably flexible to enable such bending, and resilient so that when barbs 19 and 20 reach their final position in line with openings 21 and 22 they are urged into the openings 21 and 22. To this end, space 18 is wider than the thickness of tab 17. The use of sheet material for fin 11, as opposed to injection molding can, it is believed, be advantageous in obtaining this bending of tab 17.

Thus ornament 2 has a fin 11 that bears and/or is shaped to comprise a visual indicium 12 and is separate from and securable to a lifting assembly 15 to produce an ornament 2 slideably mountable on an antenna 2 (or like structure). This principle provides a convenient way for a manufacturer to produce and offer a range of such ornaments that differ from each other in the indicia that they display but that have a major component that is common to all, in the sense mentioned earlier in this specification.

Many variations are possible and will suggest themselves to persons skilled in the art. For example, different ways of securing the two main parts together may be used. One part could be provided for example with an adhesive-covered area where the other part bears against it on assembly of the two parts.

I claim:

1. An ornament for displaying a visual indicium, wherein:
the ornament comprises an assembly mountable to an upright elongate structure and adapted to develop a lifting force in response to a wind flowing past the ornament so as to slide upwards on the structure;
the ornament comprises a first part and a separate second part engaged with each other;
the indicium is comprised in said second part and is visible when the ornament is mounted to said structure.

2. An ornament according to claim 1 wherein the first part is adapted to be mounted slideably on said upright elongate structure and comprises at least one formation adapted when maintained in a particular orientation to the wind so as to develop a lifting force.

3. An ornament according to claim 2 wherein the second part is shaped to respond to the wind by aligning itself relative to the wind so as to maintain the ornament in said particular orientation.

4. An ornament according to claim 3 wherein the second part comprises firstly a first approximately planar plate-like first portion that bears said indicium and that in use aligns with the wind and secondly a second portion that engages with said first part of the ornament.

5. An ornament according to claim 4 wherein the first portion of the second part is so shaped that at least a part of an edge thereof is shaped substantially conformably with an adjacent part of an outer edge of the indicium.

6. An ornament according to claim 4 wherein the first part and the second part are formed from different materials.

7. An ornament according to claim 4 wherein the second part is formed from a sheet material.

8. An ornament according to claim 4 wherein the first part is formed by injection moulding in a plastics material.

9. An ornament according to claim 1 wherein the indicium is borne on at least one upright surface of the second part.

10. An ornament according to claim 1 wherein the indicium is applied to said second part by one of printing, screen printing, application of a decal or application of an adhesive sticker.

11. An ornament according to claim 1 wherein the second part is snap-fittingly engageable with the first part.

12. An ornament according to claim 11 wherein the first and second parts once assembled are separable from each other only by damaging at least one of the first and second parts.

13. An ornament according to claim 1 wherein said indicium is comprised only in the second part, so that said assembly can be assembled from firstly a first part and secondly a second part that is selected from a group of second parts each adapted to be assembled to the first part and each comprising a different indicium.

14. An ornament according to claim 1 wherein said indicium is prominently comprised only in the second part, so that said assembly can be assembled from firstly a first part and secondly a second part that is selected from a group of second parts each adapted to be assembled to the first part and each comprising a different indicium.

15. An ornament for displaying a visual indicium said ornament adapted for mounting slideably on an elongate upright structure on a vehicle such as a vehicle radio antenna and adapted to be raised thereon by air flowing past the ornament when the vehicle moves and wherein:
the ornament comprises an assembly of a first part and a separate second part engaged with each other;
the first part is adapted to be mounted slideably on an elongate structure and comprises at least one formation adapted when maintained in a particular orientation to an airflow to develop a lifting force so that the ornament rises on the structure;
the second part is so shaped that when the second part is assembled to the first part the second part responds to the airflow by maintaining the first part in said particular orientation; and
the second part comprises at least one visual indicium.

16. A method for provision of a range of ornaments each member of the range bearing a different visual indicium,
the ornaments each being ornaments adapted for mounting slideably on an upright elongate structure preferably a vehicle radio antenna and adapted to be raised thereon by wind flowing past the ornament,
and the method comprising the step of supplying to consumers ornaments wherein each individual ornament comprises an assembly including a first and a second part,
the assembly being mountable to the upright elongate structure and adapted to be raised thereon by wind flowing past the ornament,
the first part having a configuration common to all members of the range and the second part comprising a visual indicium connoting a particular member of the range.

17. A method according to claim 16 wherein ornaments are supplied to consumers as separate first and second parts ready for assembly by the consumers.
